(19) United States
(12) Patent Application Publication
(10) Pub. No.: US 2006/0038713 A1
(43) Pub. Date: Feb. 23, 2006

(54) Multi-sensor target system

(76) Inventor: Mark Honore Shellans, Black Forest, CO (US)

Correspondence Address: LAW OFFICE OF DALE B. HALLING, LLC, 655 SOUTHPOINTE COURT, SUITE 100, COLORADO SPRINGS, CO, 80906, US

(21) Appl. No.: 10/919,966

(22) Filed: Aug. 17, 2004

(51) Int. Cl. H01Q 15/20

(52) U.S. Cl. 342/5; 342/7; 342/8; 342/9; 342/10; 342/53; 342/54

(57) ABSTRACT

A multi-sensor target system has a housing. A number of targets are contained in the housing. Each of the targets is detectable by a different type of sensor. A connector is coupled to each of the targets.

### RELATED APPLICATIONS

None

### FIELD OF THE INVENTION

The present invention relates generally to targets for sensors and more particularly to a multi-sensor target system.

### BACKGROUND OF THE INVENTION

There has been a trend in sensing systems to use multiple sensors that sense an object or area. These sensors detect the object or area using different types of sensors, such as infrared (thermal), near infrared, RADAR, LIDAR, sonic, ultrasonic, magnetic resonance, etc. The different types of sensors provide different types of information. For instance, the infrared (thermal) sensor in a geographic information system might indicate how crops are growing in an area while RADAR information may indicate the terrain of the area. By combining these it may be possible to determine how the terrain is affecting the crops in an area. However, this requires aligning the two types of sensors. In addition, it is time consuming just to align each of the sensors separately.

Thus there exists a need for a multi-sensor target system that overcomes these and other problems.

### SUMMARY OF INVENTION

A multi-sensor target system that overcomes these and other problems includes a housing. A number of targets are contained in the housing. Each of the targets is detectable by a different type of sensor. A connector is coupled to each of the targets. The connector may be a cord. A parachute may be coupled to the cord. At least one of the targets emits a signal. At least one of the targets does not emit a signal. The target that does not emit the signal may be self-deploying.

In one embodiment, a multi-sensor target system has an activation switch. An emitter is coupled to the activation switch. A reflector is connected to the emitter. The reflector may be a corner reflector. The emitter may emit in an infrared region of an electromagnetic spectrum. The emitter may emit in a near infrared region of an electromagnetic spectrum. The activation switch may be a magnetic switch. A second activation switch is coupled to the corner reflector. The emitter may be a light emitting diode.

In one embodiment, a multi-sensor target system has a housing. A deployment mechanism is inside the housing. A number of targets are attached to the deployment mechanism and detectable by a number of different sensors. In one embodiment each of the targets are coupled together. One of the targets may be passive. One of the targets may be active. The passive target may be a corner reflector. The deployment mechanism may include a parachute.

### BRIEF DESCRIPTION OF THE DRAWINGS

FIG. 1 is a schematic diagram of a multi-sensor target system in accordance with one embodiment of the invention;

FIG. 2 is a schematic diagram of a multi-sensor target system in accordance with one embodiment of the invention;

FIG. 3 is a schematic diagram of a target in accordance with one embodiment of the invention; and

FIG. 4 is a schematic diagram of a target in accordance with one embodiment of the invention.

### DETAILED DESCRIPTION OF THE DRAWINGS

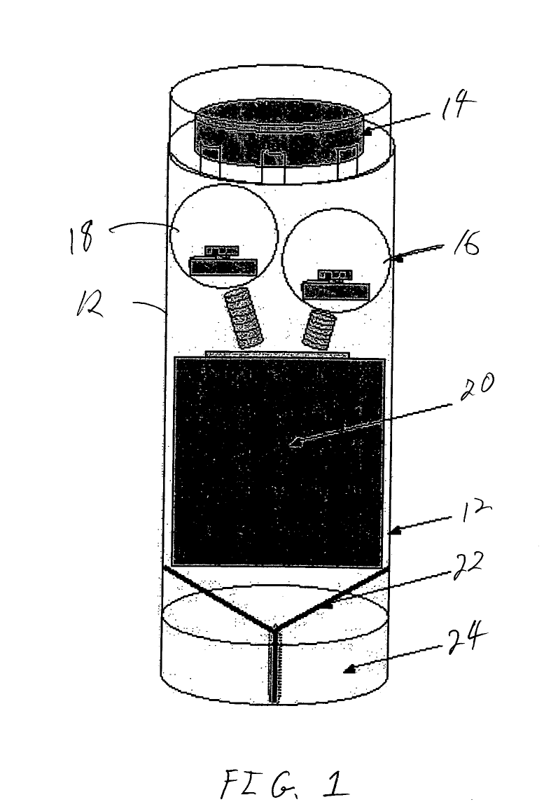

A multi-sensor target system has a number of targets that are detectable by different types of sensors. This allows a multi-sensor system to align and calibrate all its sensors simultaneously. FIG. 1 is a schematic diagram of a multi-sensor target system 10 in accordance with one embodiment of the invention. The system 10 has a housing 12 that is shown as a cylindrical canister in this embodiment. Inside of the housing 12 is a parachute 14. In the embodiment, shown the parachute is a drogue chute. Next to the parachute 14 is a near infrared emitter 16. A long wave infrared (thermal) emitter 18 is next to the near infrared emitter 16. A collapsible corner reflector 20 is also contained in the housing 12. In the embodiment shown a spring assembly 22 is used to force open a lid 24. In another embodiment a hole in the lid 22 is used to force the parachute 14 out of the housing 12. In one embodiment, the housing 12 is weighted so that it is correctly oriented to force the parachute 14 out of the housing 12.

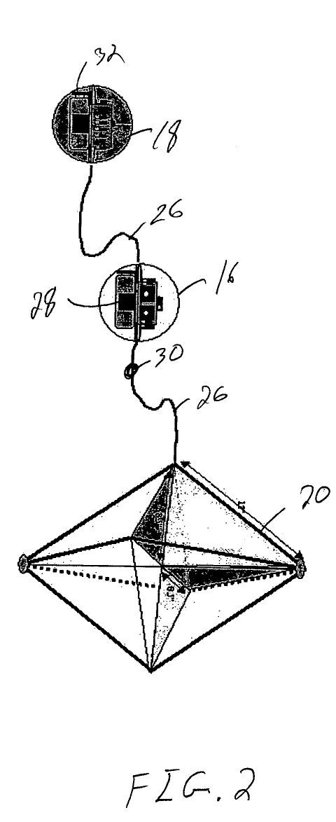

FIG. 2 is a schematic diagram of a multi-sensor target system 20 in accordance with one embodiment of the invention. This drawing shows the system 20 deployed from the housing 12 and without the parachute 14. The system 20 has a self deploying retro-reflector or corner reflector 20. A corner reflector 20 has the property that it reflects an electromagnetic wave (light) back to its source over almost any angle the light hits the corner reflector 20. As a result, a corner reflector 20 is an ideal, passive target for active sensor systems such as RADARs, LIDARs, Ultrasonic sensors, etc. The corner reflector 20 is connected to the near infrared emitter target 16. In one embodiment, the connection is a cord 26. Near infrared as used herein includes the extreme long wavelengths of visible spectrum around 700 nanometers and longer. The cord 26 also connects the near infrared emitter 16 to a long infrared emitter target 18. Long infrared covers those wavelengths of electromagnetic spectrum that are emitted by hot objects or are the thermal signature of an object.

In one embodiment, the system 20 has an activation switch. One activation switch 28 is a magnetic switch, such as a reed switch. A magnet 30 is attached to the cord 26. When the targets 16, 18, 20 are packed in the housing 20, the magnet 30 is placed next to the activation switch 28. When the parachute 14 opens the cord 26 is pulled taut and the magnet 30 is pulled away from the magnetic switch 28. As a result, the near infrared emitter target 16 starts to emit. Note that a similar type of activation switch may be used for the other sensors 18, 20.

The long wavelength infrared emitter target 18 includes an activation switch 32 that activates upon contact with water. In one embodiment, this type of activation switch is a conductivity sensing switch. When an electrical current is detected between two nodes, a switch is closed. Once the long wavelength infrared emitter target 18 is activated it results in the target emitting heat. One embodiment, of the target 18 uses the chemical process of hyper-corrosion to generate heat that can then be detected by a long wavelength infrared sensor. In one embodiment, the hyper-corrosion is created by mixing water with a magnesium-iron alloy. In this embodiment, the activation switch controls a valve that is opened to allow these chemicals to mix and produce heat. However, the present invention encompasses any other method of creating long wavelength infrared signatures.

In another embodiment, the activation switch is an accelerometer. A number of activation systems will be apparent to those skilled in the art and all such activation systems are encompassed as part of the invention.

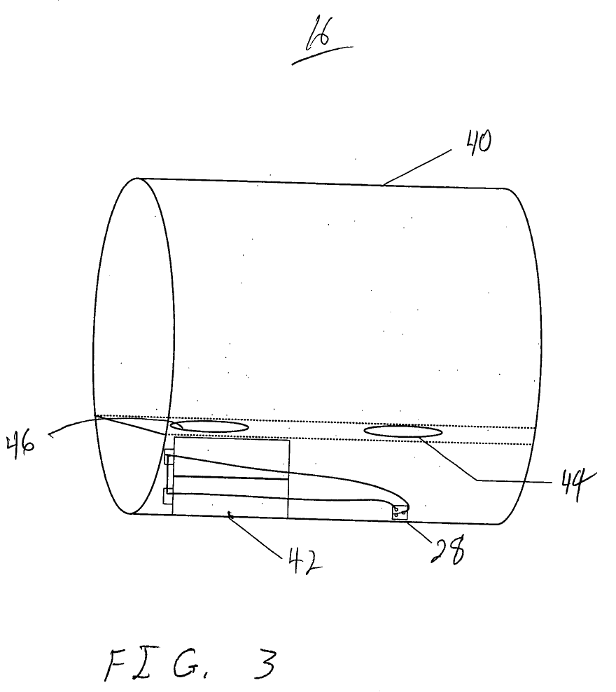

FIG. 3 is a schematic diagram of a target 16 in accordance with one embodiment of the invention. This target 16 is a near infrared or low light target. The target 16 has a clear housing 40. In one embodiment, the housing may be a plastic. Inside the housing 40, which may be water tight, is an activation switch 28. The activation switch 28 is shown as a reed switch that is activated by a magnetic field. When the magnet 26 is moved from the reed switch 28 a battery 42 is electrically connected to a number of LEDs (Light Emitting Diodes) 44, 46. In one embodiment, the LEDs 44 are red LEDs and the LEDs 46 are green LEDS. The red LEDs 44 may be either off the shelf or high intensity LEDs depending on the needs of the system. The red LEDs 44 have a near infrared electromagnetic spectrum that is well suited for calibrating low light sensors such as image intensifiers. The green LEDS 46 may be used for visible detection by a crew operating the sensors. Note that in the embodiment of the target 16 shown, the housing 40 is weighted by the battery 42. The housing 40 may be weighted by other devices also. This ensures that the LEDs 44, 46 are oriented to point up towards the sky. This is particularly suited for when the target 16 is placed in water, but will also work on hard flat surfaces, sand and other surfaces.

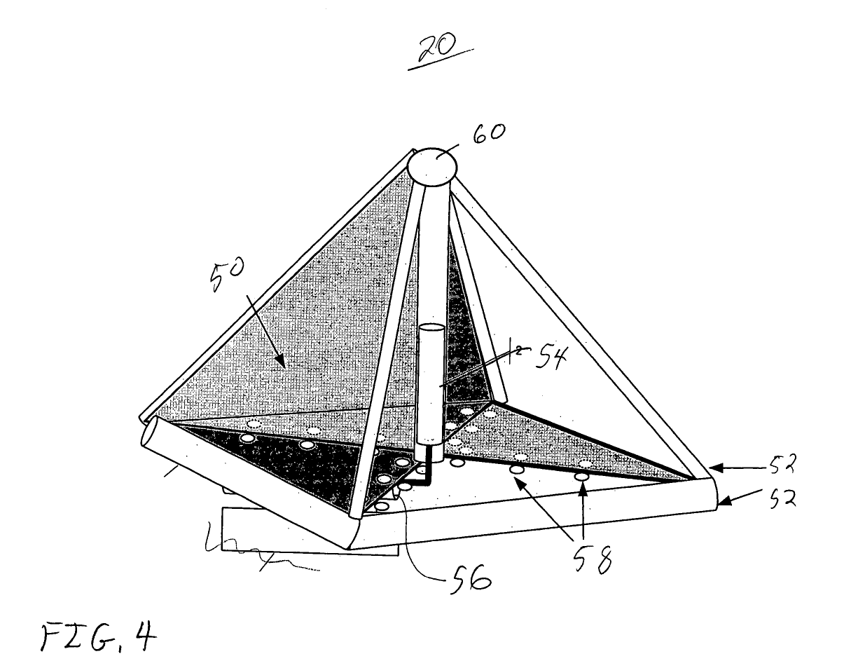

FIG. 4 is a schematic diagram of a target 20 in accordance with one embodiment of the invention. This target 20 is a half corner reflector. The half corner reflector 20 is self deploying and foldable. This allows it to be placed inside the housing 20, without the housing having to be sized specifically for the corner reflector. The corner reflector 20 has a number of metalized plastic coated conductive surfaces 50 that form right angle corner reflectors that are capable of reflecting a wide range of RADAR wavelengths. In this embodiment of the target 20, the corner reflector inflates hollow ribs 52 when an activation switch is activated. The activation switch may be a reed switch, conductivity switch, an accelerometer or other activation system. The activation system opens a valve. In one embodiment, the valve opens a CO₂ canister 54 that then fills the hollow ribs 52. In another embodiment, the valve allows a chemical reaction between acetic acid 54 and baking soda 56 or other chemicals that produce a gas capable of filling the hollow ribs 52. Drain holes or vents 58 are provided if the chemical reaction produces too much pressure on the ribs 52. The filling of the hollow tubes 52 also rights the corner reflector 20 so that the tip 60 is pointed skyward or up.

The embodiments, described herein have three different types of targets capable of being detected by three different types of sensors. However, the system 20 can be used to cover any number of different types of targets. These targets can be active or passive and may emit a signal or merely reflect a signal. The targets are shown as separate and connected by a cord, but they could be integrated into a single package. All the targets may be designed to by buoyant. All targets may be designed to be self-righting. In a water deployment of the targets they can be made self-righting by just weighting the targets so they point up. However, similar types of systems can be used to make the targets self-righting on flat hard surfaces and more complex systems may be used in more variable terrain. For instance, accelerometers may be used to determine which direction is up and the targets may have wheels to rotate the target to point up. The parachute is shown as the deployment system, but other deployment systems may be used. For instance, the system could use a passive propeller, an active chemical reaction and could include a thrust system to land the targets softly on a surface.

Thus there has been described a multi-sensor target systems that allows multiple types of sensors to calibrate simultaneously and to align with each other. The system is inexpensive and is flexible enough to encompass multiple different types of targets.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A multi-sensor target system, comprising:
a housing; and
a plurality of targets contained in the housing, each of the plurality of targets detectable by a different type of sensor.

2. The system of claim 1, further including a connector coupled to each of the plurality of targets.

3. The system of claim 2, wherein the connector is a cord.

4. The system of claim 3, further including a parachute coupled to the cord.

5. The system of claim 1, wherein at least one of the plurality of targets emits a signal.

6. The system of claim 1, wherein at least one of the plurality of targets does not emit a signal.

7. The system of claim 6, wherein the at least one of the plurality of targets that does not emit the signal is self-deploying.

8. A multi-sensor target system, comprising:
an activation switch;
an emitter coupled to the activation switch; and
a reflector connected to the emitter.

9. The system of claim 8, wherein the reflector is a corner reflector.

10. The system of claim 9, wherein the emitter emits in an infrared region of an electromagnetic spectrum.

11. The system of claim 9, wherein the emitter emits in a near infrared region of an electromagnetic spectrum.

12. The system of claim 8, wherein the activation switch is a magnetic switch.

13. The system of claim 9, further including a second activation switch coupled to the corner reflector.

14. The system of claim 11, wherein the emitter is a light emitting diode.

15. A multi-sensor target system, comprising:
a housing;
a deployment mechanism inside the housing; and
a plurality of targets that are coupled to the deployment mechanism and detectable a plurality of different sensors.

16. The system of claim 15, wherein each of the plurality of targets are coupled together.

17. The system of claim 15, wherein one of the plurality of targets is passive.

18. The system of claim 15, wherein one of the plurality of targets is active.

19. The system of claim 17, wherein the one of the plurality of targets that is passive is a corner reflector.

20. The system of claim 15, wherein the deployment mechanism includes a parachute.
